(19) United States
(12) Patent Application Publication
(10) Pub. No.: US 2011/0089886 A1
(43) Pub. Date: Apr. 21, 2011

(54) Maximum Power Point Tracking Bidirectional Charge Controllers for Photovoltaic Systems

(76) Inventor: Stephen Dubovsky, Silver Spring, MD (US)

(21) Appl. No.: 12/896,427

(22) Filed: Oct. 1, 2010

Related U.S. Application Data
(60) Provisional application No. 61/253,538, filed on Oct. 21, 2009.

(51) Int. Cl. H02J 7/00

(52) U.S. Cl. 320/101

(57) ABSTRACT

A high voltage maximum power point tracking bidirectional charge controller for photovoltaic (PV) systems having a high voltage PV array, a battery bank and a high voltage DC load comprises a DC to DC converter electrically connectable to the high voltage PV array, the battery bank, and the high voltage DC load. The converter receives DC input from the PV array and operates in a first direction to step-down the voltage of the DC input to obtain a stepped-down DC output of appropriate voltage to charge the battery bank. The converter receives DC input from the battery bank and operates in a second direction to step-up the voltage of the DC input received from the battery bank to obtain a stepped-up DC output of appropriate voltage for the high voltage DC load.

### CROSS-REFERENCE TO RELATED PATENT APPLICATION

This application claims priority from provisional patent application Ser. No. 61/253,538, filed Oct. 21, 2009, the entire disclosure of which is incorporated herein by reference.

### BACKGROUND OF THE INVENTION

1. Field of the Invention

The present invention pertains generally to photovoltaic system charge controllers and, more particularly, to high voltage photovoltaic system charge controllers that employ maximum power point tracking.

2. Brief Discussion of the Related Art:

Photovoltaic (PV) systems that produce electricity from solar energy have established themselves as a successful and reliable option for electrical power generation. Photovoltaic systems have continually been gaining in popularity as the cost of such systems has been reduced, as the cost of utility-supplied power has escalated, and as greater attention has been paid to the need for renewable, alternative energy sources. Basically, a photovoltaic system includes a photovoltaic (PV) array made up of one or more PV panels or modules composed of photovoltaic cells capable of converting solar energy into direct current (DC) electrical energy, a battery bank made up of one or more batteries for storing the electrical energy produced by the photovoltaic array, and a charge controller for controlling the charging of the one or more batteries with the electrical energy produced by the photovoltaic array. The direct current (DC) electrical energy produced by the photovoltaic array and/or stored in the battery bank is available to power a load. In some systems, the load may include an inverter used to convert the direct current (DC) electrical energy into alternating current (AC) electrical energy suitable to power AC loads. Photovoltaic systems are sometimes employed to power loads independently of utility power, such as where electrical power from a public utility grid is unavailable or not feasible, and these photovoltaic systems are commonly referred to as “off-grid” and “stand-alone” photovoltaic systems. In other instances, photovoltaic systems known as “on-grid” and “grid-connected” photovoltaic systems are employed to supply electrical power to the public utility grid as explained further below.

In accordance with programs commonly referred to as “net metering”, many public utilities provide compensation for the net electrical power that is supplied or fed into the utility grid from grid-connected photovoltaic systems. The electrical power produced by grid-connected photovoltaic systems may be used first to operate any connected end load, such as various conventional electrical appliances and devices, and the excess electrical power not consumed by the connected end load would be supplied to the utility grid. If the photovoltaic system fails to produce enough electrical power to operate the connected end load, electricity would be drawn from the utility grid to power the load. Through net metering programs, the owner of the grid-connected photovoltaic system receives compensation for the net outflow of electrical power from the photovoltaic system into the utility grid.

Grid-connected photovoltaic systems utilize inverters, conventionally referred to as “on-grid” or “grid-connected” inverters, that transform the direct current (DC) electrical power produced by the photovoltaic system into alternating current (AC) electrical power suitable for being supplied to the utility grid and for powering any connected AC end load. Grid-connected inverters normally function to ensure that the AC electrical power supplied to the utility grid is in sinusoidal form, synchronized to the frequency of the grid, and limited to a feed voltage, i.e. the output voltage of the inverter, that is no higher than the grid voltage. One way in which the AC electrical power output from an on-grid inverter can be supplied to the utility grid and/or a connected AC end load involves connecting the inverter output to an electrical distribution panel as typically found in residential, commercial, business and/or other types of buildings or structures. The source of DC electrical input to the on-grid inverter may come from various sources including electrical energy stored in the battery bank of the photovoltaic system, flywheels and/or fuel cells, for example.

Photovoltaic systems have been designed with traditional charge controllers that do not employ maximum power point tracking (MPPT), and such controllers may be referred to as non-MPPT charge controllers. Non-MPPT charge controllers connect the PV array directly to the battery bank for charging. Usually there is a mismatch between the output voltage of the PV array and the voltage required to charge the battery bank that results in under-utilization of the maximum power output from the PV array. The reason for the mismatch is that most PV modules are rated to produce a nominal 12V under standard test conditions but, because they are designed for worse than standard test conditions, in actual fact they produce significantly more voltage. On the other hand, a nominal 12V battery for example requires close to an actual 12V (14V typically) depending on battery state of charge. When a non-MPPT charge controller is charging the battery, the PV module is frequently forced to operate at a battery voltage that is less than the optimal operating voltage at which the PV module is capable of producing its maximum power. Hence, non-MPPT charge controllers artificially limit power production to a sub-optimal level by constraining the PV array from operating at maximum output power.

A maximum power point tracking (MPPT) charge controller addresses the aforesaid disadvantage of non-MPPT charge controllers by managing the voltage mismatch between the PV array and the battery bank through the use of power electronics. The primary functions performed by MPPT charge controllers involve measuring the PV module output to find the maximum power voltage (Vₘₚ), i.e. the voltage at which the PV module is able to produce maximum power, and operating the PV module at the maximum power voltage to extract or harvest full power (watts) from the PV array, regardless of the present battery voltage (V_{B}).

Photovoltaic modules are made up of photovoltaic (PV) cells that have a single operating point where the values of the current (I) and voltage (V) of the cell result in a maximum power output. The maximum power voltage Vₘₚ varies with operating conditions including weather, sunlight intensity, shading, and PV cell temperature. As the maximum power voltage Vₘₚ of the PV module varies, the MPPT charge controller “tracks” the Vₘₚ and adjusts the ratio between the maximum power voltage and the current delivered to the battery in order to match what the battery requires. The MPPT charge controller utilizes a control circuit or logic to search for the maximum power output operating point and employs power electronics to extract the maximum power available from a PV module.

A MPPT charge controller employs power electronics that have a higher input voltage than output voltage, hence Vₘₚ>V_{B}. The power electronics are conventionally designed to include a high frequency DC to DC converter that receives the maximum power voltage from the PV array as converter input and converts the maximum power voltage to battery voltage as converter output. An increase in battery charge current is realized by harvesting PV module power that would be left unharvested using a non-MPPT charge controller. As the maximum power voltage varies, the actual charge current increase that is realized will likewise vary. Generally speaking, the greater the mismatch or disparity between the PV array maximum power voltage and the battery voltage, the greater the charge current increase will be. The charge current increase will ordinarily be greater in cooler temperatures because the available power output and the maximum power voltage of the PV module increase as the photovoltaic cell temperature decreases. In addition, lower battery voltage, as in the case of a highly discharged battery, will result in a greater charge current increase.

Most MPPT charge controllers utilize power electronics designed to include a “buck” converter having topology to “buck” a higher input voltage to a lower output voltage. Buck converters, also known as “step-down” converters, are familiar in the field of power electronics and essentially include an inductor and two complementary switches to achieve unidirectional power flow from input to output. A first of the switches is ordinarily a controlled switch such as a MOSFET or transistor, and the second of the switches is ordinarily an uncontrolled switch such as a diode. The buck converter alternates between connecting the inductor to the input voltage (V_{A}) from the PV array to store energy in the inductor and discharging the inductor into the battery bank. When the first switch is turned “on” for a time duration, the second switch becomes reverse biased and the inductor is connected to the input voltage V_{A}. There is a positive voltage (V_{L}) across the inductor equal to the input voltage V_{A} minus the output voltage (V₈), hence V_{L}=V_{A}−V_{B} and there is an increase in the inductor current (I_{L}). In this “on” state, energy is stored in the inductor. When the first switch is turned “off”, inductor current I_{L} continues to flow due to the inductor energy storage, resulting in a negative voltage across the inductor (V_{L}=−V_{B}). The inductor current now flows through the second switch, which is forward biased, and current I_{L} through the inductor decreases. In this “off” state, energy continues to be delivered to the output until the first switch is again turned “on” to begin another on-off cycle.

Use of a buck converter configuration in conventional MPPT charge controllers for photovoltaic systems has various disadvantages including high peak currents and voltages with attendant high power losses, and increasing control problems as the input voltage increases. At the present time, conventionally available photovoltaic system charge controllers that utilize a buck converter configuration to implement maximum power point tracking (MPPT) are limited to an input of 150V, an exception being the MPPT charge controller developed by Australian Energy Research Laboratory (AERL) which is capable of handling an input of 250V. Conventional on-grid inverters, however, operate with high voltage PV arrays up to 600V, such that presently available MPPT charge controllers for photovoltaic systems are generally unsuitable for use in grid-connected photovoltaic systems due to their inability to handle the high voltage.

### SUMMARY OF THE INVENTION

A high voltage maximum power point tracking bidirectional charge controller for photovoltaic systems that have a high voltage photovoltaic array, a battery bank and a high voltage DC load comprises a bidirectional isolated DC to DC converter electrically connectable to the high voltage photovoltaic array, the battery bank, and the high voltage DC load. The bidirectional isolated DC to DC converter receives DC input from the photovoltaic array and operates in a first direction to step down the voltage of the DC input received from the photovoltaic array to obtain a stepped-down DC output of appropriate voltage to charge the battery bank. The converter receives DC input from the battery bank and operates in a second direction to step up the voltage of the DC input received from the battery bank to obtain a stepped-up DC output of the appropriate voltage for the high voltage DC load. The converter performs maximum power point tracking of the high voltage PV array while simultaneously feeding the high voltage DC load and providing interface to the battery bank. The high voltage DC load can be a grid-connected inverter for transforming DC electricity received from the charge controller into AC electricity appropriate for being supplied to a public utility grid and to a connected AC load. The bidirectional isolated DC to DC converter may include a full-bridge bidirectional isolated DC to DC converter configuration, a dual active full-bridge bidirectional isolated DC to DC converter configuration, or a parallel resonant bidirectional isolated DC to DC converter configuration. The bidirectional isolated DC to DC converter may include a first bridge, a second bridge, and a switch located along the electrical path between the photovoltaic array and the battery bank to prevent current from flowing from the battery bank back to the photovoltaic array when the voltage of the DC input from the photovoltaic array is less than the voltage of the DC output from the converter to the battery bank. When the maximum output power of the photovoltaic array is higher than the power required by the high voltage DC load, the bidirectional isolated DC to DC converter delivers the power difference to the battery bank. When the power required by the high voltage DC load is higher than the maximum power output of the PV array, the converter takes the power difference from the battery bank and delivers it to the high voltage DC load. The high voltage maximum power point tracking bidirectional charge controller tracks the maximum power operating point of the photovoltaic array, which corresponds to average power, by adjusting battery input power to match the difference between the maximum power operating point of the PV array and the input power required by the high voltage DC load. The converter operates in a back-up mode when the public utility grid is down, such that the converter supplies the stepped-up DC output from the battery bank to the inverter to power any connected AC load when the connected AC load requires more power than is available from the PV array, and the converter supplies the stepped-down DC output from the PV array to charge the battery bank, if needed, when the AC load requires less power than is available from the PV array. The high voltage maximum power point tracking bidirectional charge controller can be used in photovoltaic systems having a high voltage photovoltaic array of up to 600V.

A method of charge control for grid-connected photovoltaic systems having a high voltage photovoltaic array, a battery bank and a grid-connected inverter comprising the steps of delivering DC electricity produced by the high voltage photovoltaic array as DC input to a bidirectional DC to DC converter of a maximum power point tracking charge controller; stepping-down the voltage of the DC input in a first direction through the DC to DC converter to obtain a stepped-down DC voltage; delivering the stepped-down DC voltage from the maximum power point tracking charge controller to the battery bank; delivering DC electricity from the battery bank as DC input to the DC to DC converter of the maximum power point tracking charge controller; stepping-up the voltage of the DC input from the battery bank in a second direction through the DC to DC converter to obtain a stepped-up DC voltage; and delivering the stepped-up DC voltage from the maximum power point tracking charge controller to the grid-connected inverter.

Various objects, advantages and benefits of the invention will become apparent from the following detailed description of the invention taken in conjunction with the accompanying drawings.

### BRIEF DESCRIPTION OF THE DRAWINGS

FIG. 1 is a diagram of a grid-connected photovoltaic system having a high voltage maximum power point tracking bidirectional charge controller.

FIG. 2 is a diagram showing a photovoltaic array used to charge a DC load through a standard DC to DC converter as known in the prior art.

FIG. 3 is an electrical diagram of a prior art step-down or buck converter configuration as typically employed in standard DC to DC converters.

FIG. 4 is an electrical diagram illustrating an aspect of a prior art step-down converter configuration.

FIG. 5A is an electrical diagram representing the flow of electric current in the step-down converter configuration of FIG. 4 when the switch is in position 1.

FIG. 5B is an electrical diagram representing the flow of electric current in the step-down converter configuration of FIG. 4 when the switch is in position 2.

FIG. 6 is a graph depicting the inductor voltage in the step-down converter configuration of FIG. 4 for the time during which the switch is in position 1 and position 2.

FIG. 7 is a graph depicting the inductor current in the step-down converter configuration of FIG. 4 for the time during which the switch is in position 1 and position 2.

FIG. 8 is a graph representing the DC component of the switch output voltage in the step-down converter configuration of FIG. 4 for the time during which the switch is in position 1 and position 2.

FIG. 9 is a graph of the switch output voltage in the step-down converter configuration of FIG. 4 based on Fourier analysis.

FIG. 10 an electrical diagram illustrating an aspect of a prior art step-up converter configuration as typically employed in standard DC to DC converters.

FIG. 11A is an electrical diagram representing the flow of electric current in the step-up converter configuration of FIG. 10 when the switch is in position 1.

FIG. 11B is an electrical diagram representing the flow of electric current in the step-up converter configuration of FIG. 10 when the switch is in position 2.

FIG. 12 is a graph representing the inductor voltage in the step-up converter configuration of FIG. 10 for the time during which the switch is in position 1 and position 2.

FIG. 13 is a graph representing the current through the capacitor in the step-up converter configuration of FIG. 10 for the time during which the switch is in position 1 and position 2.

FIG. 14 is a graph of current through the inductor in the step-up converter configuration of FIG. 10 for the time during which the switch is in position 1 and position 2.

FIG. 15 is a graph depicting voltage as a function of time corresponding to position 1 and position 2 of the switch in the step-up converter configuration of FIG. 10.

FIG. 16 is a graph representing the conversion ratio of the step-up converter configuration of FIG. 10.

FIG. 17 is an electrical diagram of a prior art unidirectional transformer-isolated DC to DC converter configuration.

FIG. 18 is an electrical diagram of an alternative prior art unidirectional transformer-isolated DC to DC converter configuration.

FIG. 19 illustrates wave forms corresponding to the converter configuration of FIG. 17.

FIG. 20 is a diagram of a photovoltaic system having an isolated DC to DC converter that may employ the unidirectional transformer-isolated DC to DC converter configurations of FIG. 17 or FIG. 18 to serve as a step-up converter.

FIG. 21 is a diagram that shows a photovoltaic system modified from that shown in FIG. 20 so that the converter configurations of FIG. 17 or FIG. 18 serve as a step-down converter.

FIG. 22 is a diagram depicting a photovoltaic system having a high voltage maximum power point tracking bidirectional charge controller with an isolated DC to DC converter that includes a bidirectional isolated DC to DC converter configuration.

FIG. 23A is an electrical diagram illustrating a full-bridge bidirectional isolated DC to DC converter configuration for the high voltage maximum power point tracking bidirectional charge controller of FIG. 22.

FIG. 23B is an electrical diagram illustrating a dual active full-bridge bidirectional isolated DC to DC converter configuration for the high voltage maximum power point tracking bidirectional charge controller of FIG. 22.

FIG. 23C is an electrical diagram illustrating a parallel resonant bidirectional isolated DC to DC converter configuration for the high voltage maximum power point tracking bidirectional charge controller of FIG. 22.

FIG. 24 is a diagram depicting the photovoltaic system of FIG. 22 with a grid-connected inverter as the high voltage DC load.

FIG. 25A is a graph depicting the frequency of the voltage supplied to the utility grid from the inverter of FIG. 24.

FIG. 25B is a graph demonstrating that the power delivered to the utility grid by the inverter of FIG. 24 varies at twice the frequency of the voltage supplied to the utility grid.

FIG. 25C is a graph depicting the input power drawn by the inverter of FIG. 24 in the situation where the high voltage maximum power point tracking bidirectional charge controller would track the maximum power operating point of the photovoltaic array.

FIG. 25D is a graph showing battery input power adjusted by the high voltage maximum power point tracking bidirectional charge controller to match the difference between the maximum power operating point of the photovoltaic array and the input power required by the inverter.

FIG. 26 is a diagram depicting a modified bidirectional isolated DC to DC converter configuration for use in the high voltage maximum power point tracking bidirectional isolated charge controller of FIG. 22.

FIG. 27 is a diagram illustrating a further modified bidirectional isolated DC to DC converter configuration for use in the high voltage maximum power point tracking bidirectional charge controller in FIG. 22.

### DETAILED DESCRIPTION OF THE INVENTION

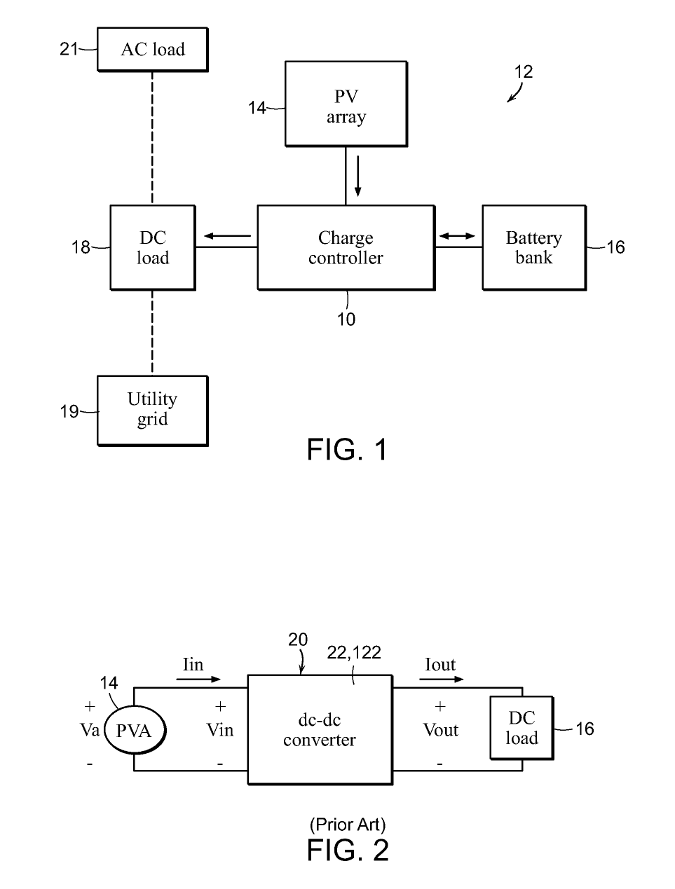

A high voltage maximum power point tracking (MPPT) bidirectional charge controller 10 is illustrated diagrammatically in FIG. 1 incorporated in a photovoltaic (PV) system 12. The PV system 12 comprises a high voltage photovoltaic (PV) array 14 including one or more photovoltaic (PV) modules or panels, a battery bank 16 including one or more batteries, a high voltage DC load 18, and the high voltage MPPT bidirectional charge controller 10 electrically connected to the PV array 14, to the battery bank 16 and to the load 18. As described further below, the high voltage load 18 may be an on-grid or grid-connected inverter for converting direct current (DC) electrical energy into alternating current (AC) electrical energy suitable for being supplied or fed into a public utility grid 19 connected to the DC load 18, i.e. on-grid inverter, as in the case where the PV system 12 is a grid-connected PV system. When the PV system 12 is a grid-connected PV system, the PV array 14 is normally a high voltage PV array, i.e. up to 600V, for compatibility with conventional on-grid inverters. The DC load 18, i.e. on-grid inverter, may also be connected to an AC load 21, which may include various conventional electrical appliances and devices. In this way, electrical power produced by the PV system 12 can be used first to operate any connected AC load 21 and the excess power not consumed by the AC load would be supplied to the utility grid 19. The AC electrical power output from the load 18, i.e. on-grid inverter, can be supplied to the utility grid 19 and/or connected AC load 21 by connecting the inverter output to an electrical distribution panel as typically found in residential, commercial, business and/or other types of buildings or structures. In off-grid photovoltaic systems, DC loads such as lights, inverters and pumps may be directly connected to the battery bank 16.

The PV modules of the PV array 14 are composed of photovoltaic (PV) cells capable of converting solar energy into direct current (DC) electrical energy. The battery bank 16 is capable of storing the DC electrical energy produced by the PV array 14, and the MPPT bidirectional charge controller 10 controls charging of the battery bank 16 with the electrical energy produced by the PV array 14. The MPPT bidirectional charge controller 10 receives input voltage from the PV array 14, and output voltage from the MPPT charge controller 10 is supplied to the battery bank 16. The electrical energy produced by the PV array 14 and stored in the battery bank 16 is available to power the load 18, which supplies AC electrical output to the AC load 21 and/or the utility grid 19. The MPPT bidirectional charge controller 10 also controls the transmission of DC electrical energy from the battery bank 16 to the load 18 as explained further below. Accordingly, the MPPT charge controller 10 may be referred to as “bidirectional” since it operates in one direction to deliver DC electrical energy to the battery bank 16 from the PV array 14 and operates in the opposite direction to deliver DC electrical energy from the battery bank 16 to the load 18.

The maximum power voltage (Vₘₚ) of the PV array 14 is the voltage where the product of current and voltage (amps×volts) is greatest, and it varies with operating conditions including weather, sunlight intensity, shading, and photovoltaic cell temperature. The MPPT bidirectional charge controller 10 employs maximum power point tracking (MPPT) to manage the disparity between the output voltage of the PV array 14 and the voltage required to charge the battery bank 16. The MPPT bidirectional charge controller 10 operates a maximum power point tracking algorithm to identify and track the maximum power voltage Vₘₚ of the PV array 14, even as the maximum power voltage Vₘₚ changes with operating conditions, and utilizes power electronics that have a higher input voltage V_{A} than output voltage V_{B} to adjust the ratio between the maximum power voltage Vₘₚ and the current delivered to the battery bank 16 in order to match what the battery bank requires. The maximum power point tracking algorithm, which is fully automatic, tracks the maximum power voltage Vₘₚ as it varies and ensures that maximum power is harvested from the PV array 14 throughout the course of each day. Any appropriate MPPT algorithm may be used in the MPPT bidirectional charge controller 10 to effectuate maximum power point tracking of the PV array, including conventional MPPT algorithms. The power electronics used in the MPPT bidirectional charge controller 10 receives the Vₘₚ from the PV array 14 as input V_{A} and converts the Vₘₚ to battery voltage V_{B} as output. In addition, the power electronics used in the MPPT bidirectional charge controller 10 controls the transmission of DC electrical energy from the battery bank 16 to the load 18 by converting the DC electrical energy stored in the battery bank 16 to DC electrical energy of the appropriate voltage for the load 18. Where the load 18 includes a conventional on-grid inverter, the charge controller 10 converts DC electricity from the battery bank 16 into DC electricity of sufficiently high voltage for the on-grid inverter.

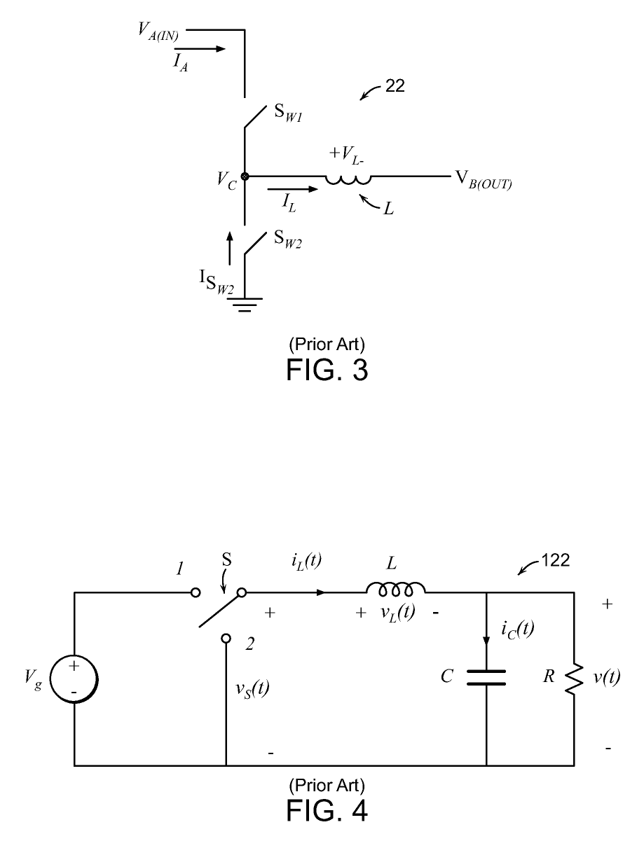

In order to lay the groundwork for understanding the approach taken in the MPPT bidirectional charge controller 10, it is helpful to consider prior DC to DC converter configurations for charge controllers used in PV systems. FIG. 2 is a diagram depicting a PV array 14 (PVA) used to charge a battery bank 16 (DC Load) through a standard DC to DC converter 20 as known in the prior art. When the voltage of the PV array 14 is higher than the voltage of the battery bank 16 in the system of FIG. 2, a “step-down” or “buck” converter configuration 22 is typically employed in the DC to DC converter 20 to “buck” the higher input voltage (Vᵢₙ) to the lower output voltage (Vₒᵤₜ) required by the battery bank 16. As depicted in the electrical diagram of FIG. 3, a typical step-down or buck converter configuration 22 essentially includes an inductor L and two complementary switches S_{w1} and S_{w2} to achieve unidirectional electrical power flow from the buck converter input to the buck converter output. The input voltage V_{A(IN)} to the buck converter configuration 22 that is received from the PV array is oftentimes greater than the output voltage V_{B(OUT)} needed from the buck converter configuration 22 to charge the battery bank, hence V_{A(IN)}>V_{B(out)}. Switch S_{w1} is a controlled switch such as a MOSFET or transistor, and the complementary switch S_{w2} is usually an uncontrolled switch such as a diode. During a switching cycle, the switch S_{w1} is turned “on” for a time duration and is then turned “off” for a time duration. The buck converter configuration 22 alternates between connecting the inductor L to the input voltage V_{A(IN)} from the PV array to store energy in the inductor L and connecting the inductor L to ground to discharge the stored energy as the output voltage V_{B(OUT)} from the buck converter configuration 22 into the battery bank.

When the switch S_{w1} is turned on, the inductor L is connected to the input voltage V_{A(IN)} and the switch S_{w2} becomes reverse biased or turned off, resulting in a positive voltage V_{L} across the inductor equal to V_{A(IN)}−V_{B(OUT)} and an increase in the inductor current I_{L}. Furthermore, when the switch S_{w1} is on, the input current I_{A} is equal to the inductor current I_{L} (I_{A}=I_{L}), and the current I_{sw2} across switch S_{w2} is equal to zero. In this “on” state, energy is stored in the inductor L. When the switch S_{w1} is turned off, inductor current I_{L} continues to flow due to the inductor energy storage, resulting in a negative voltage V_{L} across the inductor equal to −V_{B(OUT)}. The inductor current now flows through the switch S_{w2}, which is forward biased or turned on, and current I_{L} through the inductor decreases. The input current I_{A} is now equal to zero and the current I_{sw2} across switch S_{w2} is equal to the inductor current I_{L}. In this “off” state, electrical energy continues to be delivered as output until the switch S_{w1} is again turned on to begin another on-off switching cycle.

If a high voltage PV array is used to supply V_{IN} to the DC to DC converter 20 depicted in FIG. 2, the converter 20 would be required to handle all the output power as represented by the following equations:

$${P}_{OUT} = {V}_{OUT} \times {I}_{OUT} ;$$

$${P}_{IN} = {V}_{IN} \times {I}_{IN} = \frac{{P}_{OUT}}{η} = \frac{{V}_{OUT} \times {I}_{OUT}}{η} ;$$

where η is the converter's efficiency and the input voltage V_{IN} is the high voltage input received from the high voltage PV array.

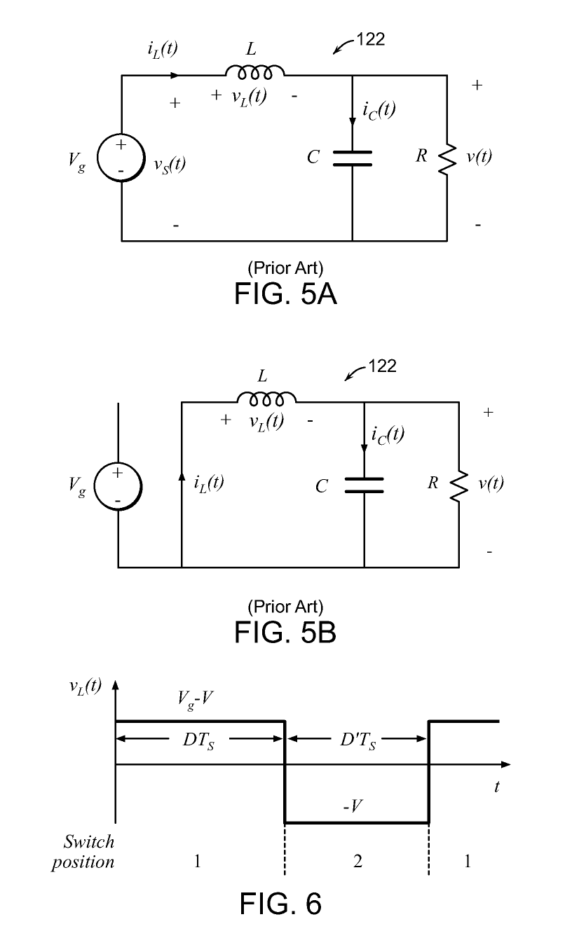

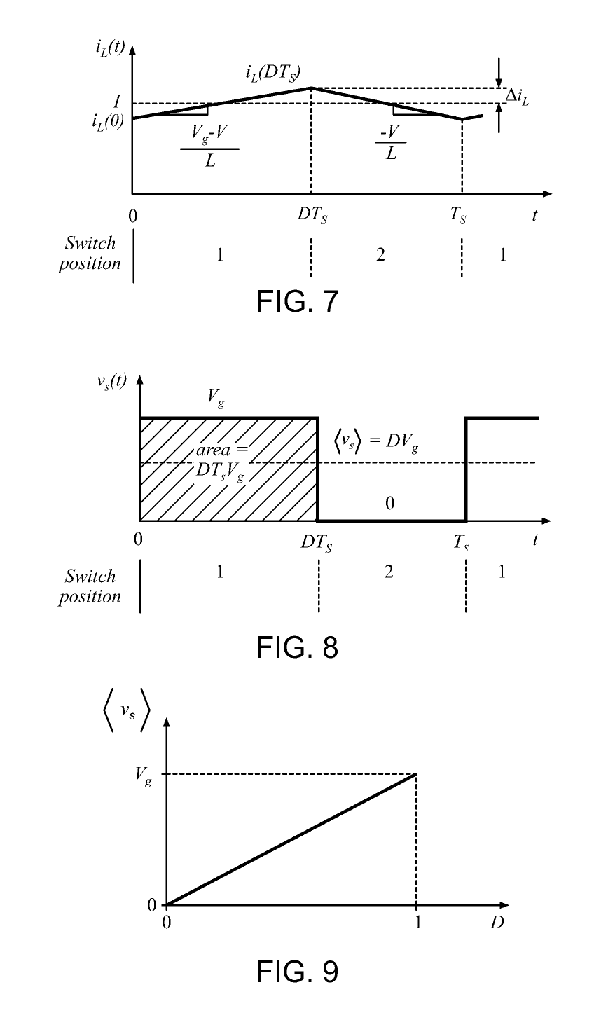

The foregoing principle is further understood with reference to FIGS. 4, 5A, 5B, 6, 7, 8 and 9. FIG. 4 is an electrical diagram illustrating an aspect of a standard step-down or buck converter configuration 122 for the DC to DC converter 20 depicting switch S, inductor L, capacitor C and resistor R. FIG. 5A is an electrical diagram representing the flow of electrical current in the buck converter configuration 122 when the switch S is turned “on” (position 1 in FIG. 4), and FIG. 5B is an electrical diagram representing the flow of electrical current in the buck converter configuration 122 when the switch S is turned “off” (position 2 in FIG. 4). FIG. 6 is a graph depicting the inductor voltage v_{L}(t) in the buck converter configuration 122 for the time t during which the switch S is in position 1 and position 2. FIG. 7 is a graph representing the inductor current i_{L}(t) in the buck converter configuration 122 for the time t during which the switch S is in position 1 and position 2. FIG. 8 is a graph showing the DC component of the switch output voltage vₛ(t) in the buck converter configuration 122 for the time t during which the switch S is in position 1 and position 2. FIG. 9 is a graph of the switch output voltage vₛ for the buck converter configuration 122 based on the following Fourier analysis:

$$〈 {υ }_{s} 〉 = \frac{1}{{T}_{s}} = {\int }_{o}^{Ts} {υ }_{s} ( t ) d t ;$$

$$〈 {υ }_{s} 〉 = \frac{1}{{T}_{s}} = ( {DT}_{s} {V}_{g} ) = {DV}_{g} .$$

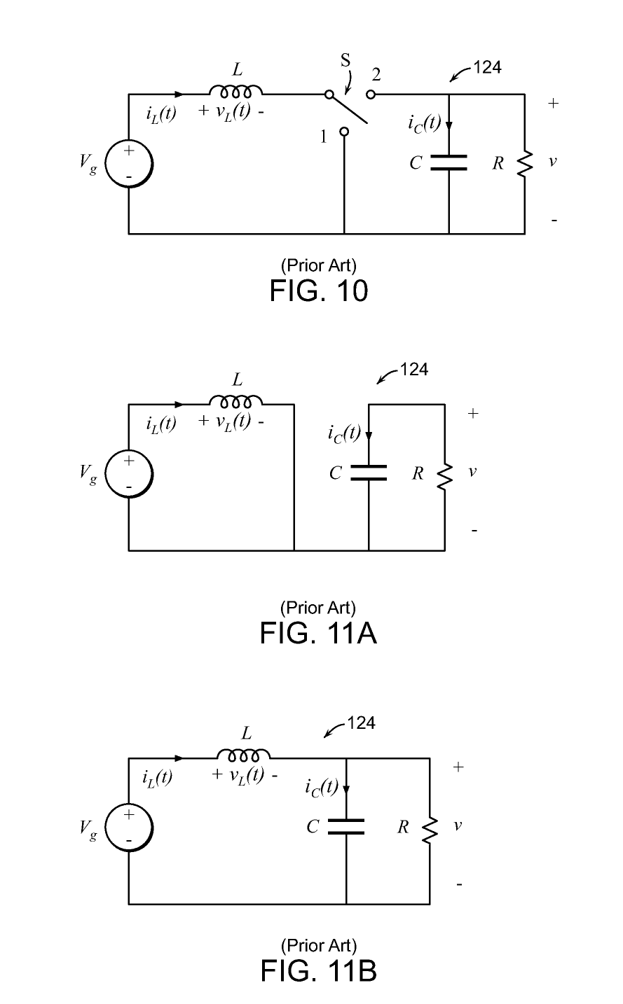

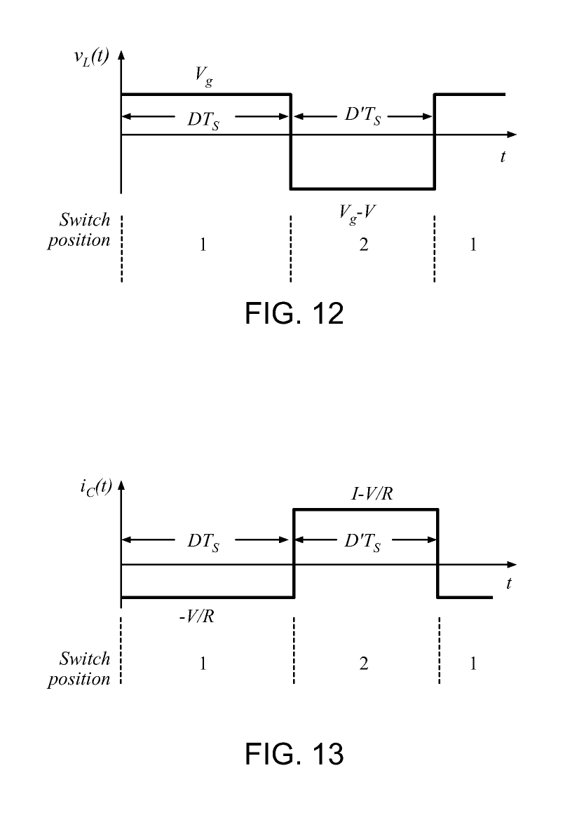

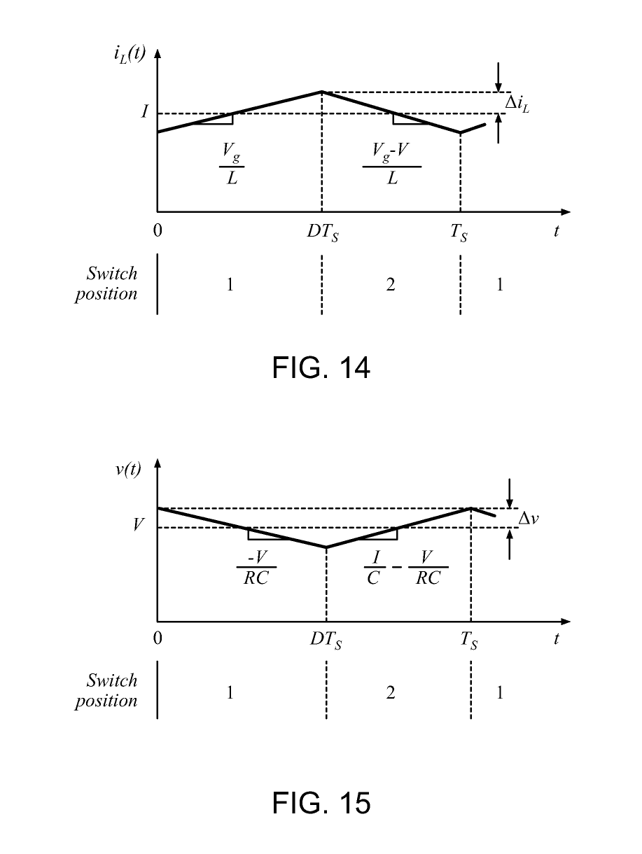

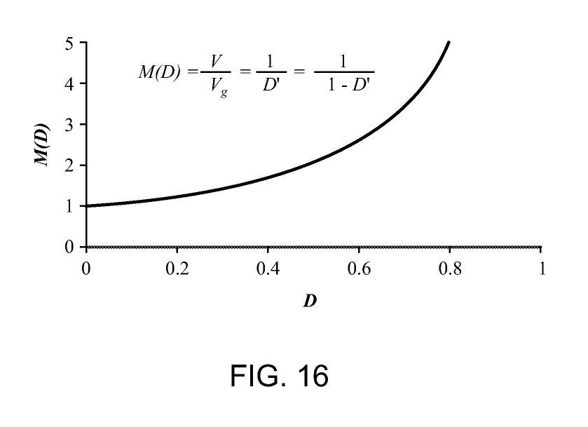

In addition to voltage stepping-down applications as described above, DC to DC converters have been used in the past to “boost” or “step-up” a lower input voltage to a higher output voltage, and these types of DC to DC converters may be referred to as step-up or boost converters. FIG. 10 is an electrical diagram depicting an aspect of a standard step-up or boost converter configuration 124 as used in standard step-up DC to DC converters and including switch S, inductor L, capacitor C and resistor R. FIG. 11A is an electrical diagram representing the flow of electrical current in the boost converter configuration 124 when the switch S is in position 1 of FIG. 10, and FIG. 11B is an electrical diagram representing the flow of electrical current in the boost converter configuration 124 when the switch S is in position 2 of FIG. 10. FIG. 12 is a graph representing the inductor voltage v_{L}(t) in the boost converter configuration 124 for the time t during which the switch S is in position 1 and position 2. FIG. 13 is a graph depicting current i_{c}(t) through the capacitor in the boost converter configuration 124 for the time t during which the switch S is in position 1 and position 2. FIG. 14 is a graph of current i_{L}(t) through the inductor in the boost converter configuration 124 for the time t when switch S is in position 1 and position 2. FIG. 15 depicts voltage v(t) as a function of time t corresponding to position 1 and position 2 of the switch S in the boost converter configuration 124. FIG. 16 is a graph representing the conversion ration M(D) of the boost converter configuration 124.

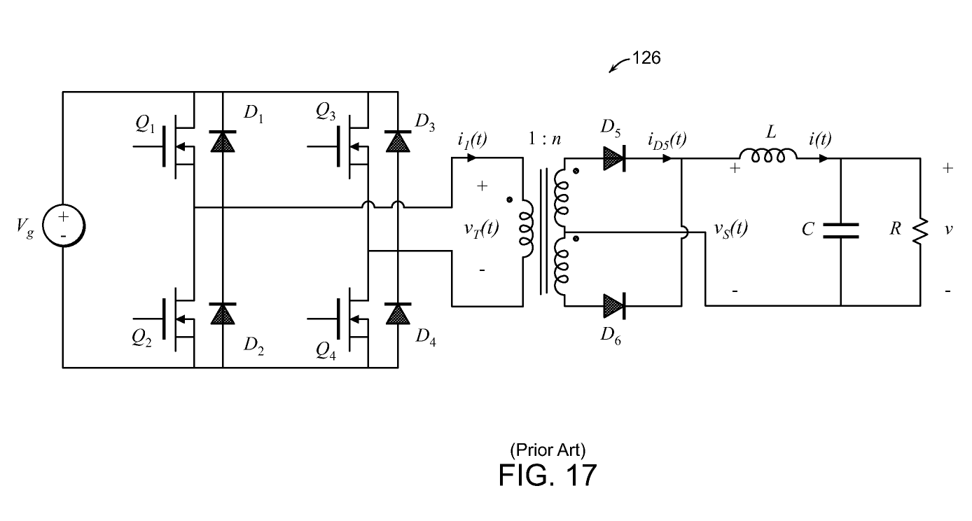

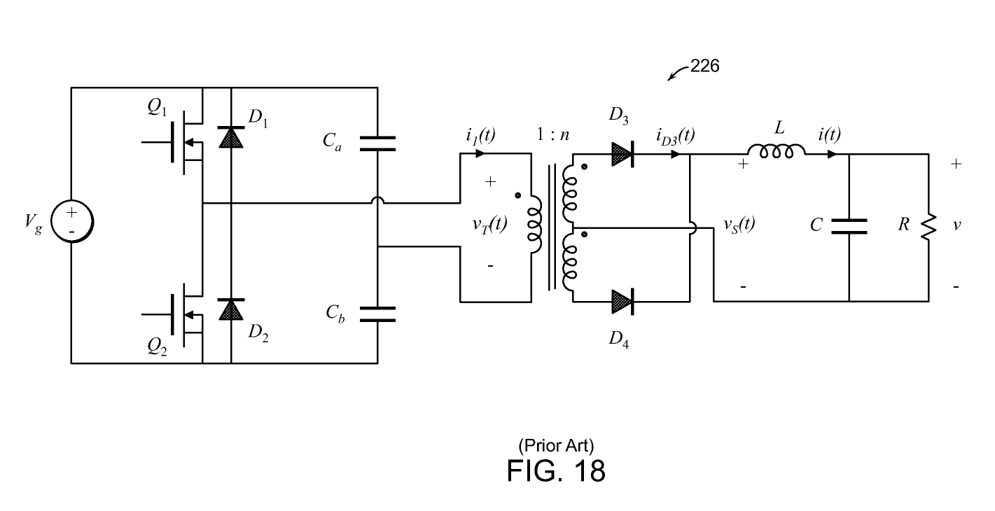

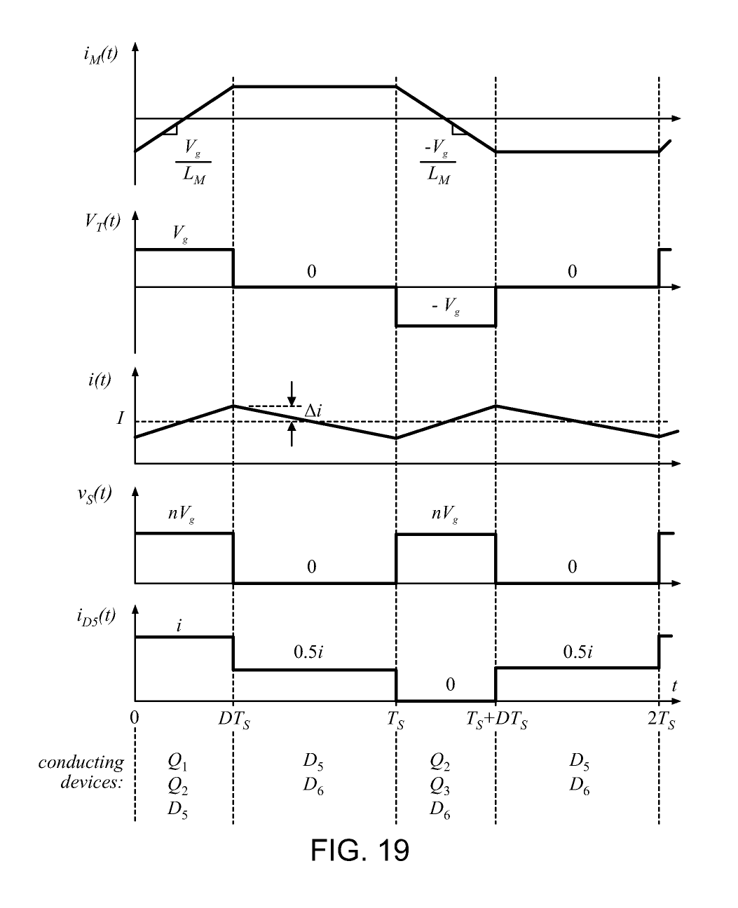

In some voltage stepping-up applications, and stepping-down applications depending on transformer ratio, a unidirectional transformer-isolated DC to DC converter configuration may be employed in DC to DC converters instead of a standard boost converter or buck converter configuration. FIG. 17 is an electrical diagram representative of a conventional unidirectional transformer-isolated DC to DC converter configuration 126 having a full-bridge isolated buck converter configuration (with turns ratio), where V=<vₛ>, V=nDV_{g} and M(D)=nD. FIG. 18 is an electrical diagram representative of an alternative prior art unidirectional transformer-isolated DC to DC converter configuration 226 having a half-bridge isolated buck converter configuration. In the arrangement of FIG. 18, the voltage at the capacitor centerpoint is 0.5V_{g}; vₛ(t) is reduced by a factor of two; and M=0.5nD. The waveforms corresponding to the converter configuration 126 having the full-bridge isolated buck converter configuration are shown in FIG. 19. The iₘ(t) waveform represents the magnetizing current in the transformer. The v_{T}(t) waveform represents the transformer primary voltage. The vₛ(t) waveform represents the input inductor ripple current. The vₛ(t) waveform represents the transformer secondary voltage. The i_{D5}(t) waveform represents current through the conducting device D₅.

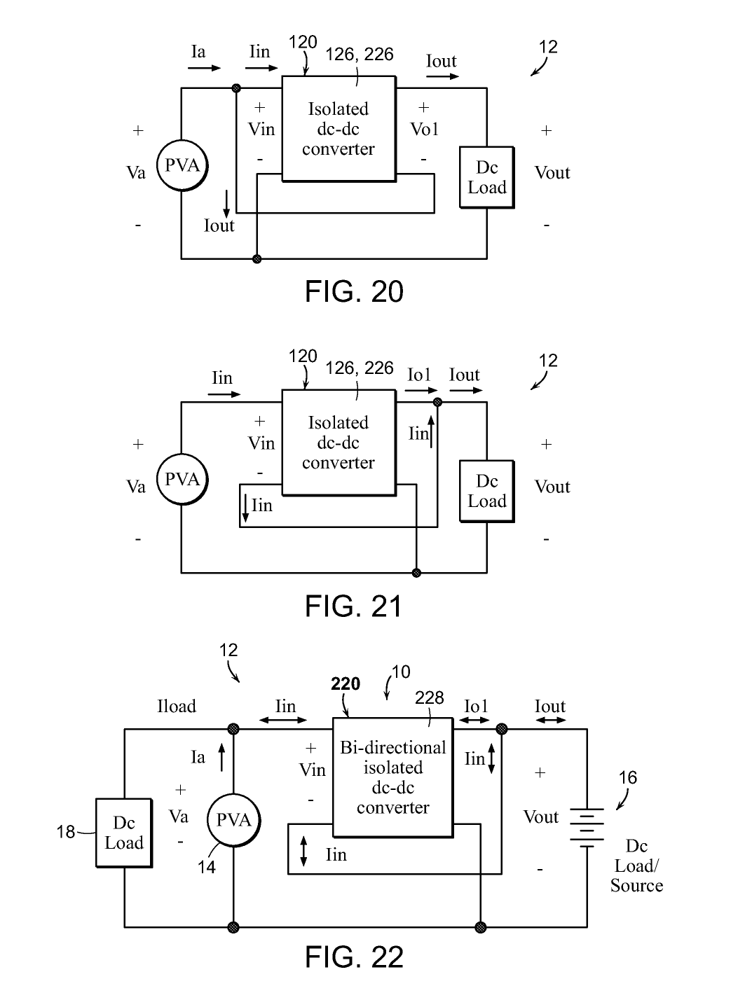

FIG. 20 is a diagram of a photovoltaic (PV) system 12 having an isolated DC to DC converter 120 that may include the unidirectional transformer-isolated DC to DC converter configuration 126 or 226. Employing the unidirectional transformer-isolated DC to DC converter configuration 126 or 226 in the isolated DC to DC converter 120, the output voltage of the converter 120 can be connected in series with its input voltage, as depicted in FIG. 20, in order to reduce both the amount of power handled by the converter 120 and the highest voltage level seen by the electrical components of the converter. In the step-up series connected isolated DC to DC converter 120 of FIG. 20, the following relations apply:

$${P}_{OUT} = {V}_{OUT} \times {I}_{OUT} ;$$

$${V}_{01} = {V}_{OUT} - {V}_{IN} ;$$

$${P}_{IN} = {V}_{IN} \times {I}_{IN} = \frac{{V}_{01} \times {I}_{OUT}}{η} = \frac{( {V}_{OUT} - {V}_{IN} ) \times {I}_{OUT}}{η} ;$$

where η is the converter's efficiency.

The diagram of FIG. 21 depicts an arrangement for a PV system 12 that is modified from FIG. 20 so that the output and input voltage ports of the isolated DC to DC converter 120, which again employs the DC to DC converter configuration 126 or 226, are connected in series to create a topology that operates as a voltage stepping-down system. The converter topology depicted in FIG. 21 reduces the amount of power handled by the isolated DC to DC converter 120 as well as the highest voltage seen by its electrical components as demonstrated by the following:

$${P}_{01} = {V}_{OUT} \times {I}_{01} ;$$

$${I}_{01} = {I}_{OUT} - {I}_{IN} ;$$

$${V}_{IN} = {V}_{a} - {V}_{OUT} ;$$

$${P}_{IN} = {V}_{IN} \times {I}_{IN} = \frac{{I}_{01} \times {V}_{OUT}}{η} = \frac{( {I}_{OUT} - {I}_{IN} ) \times {V}_{OUT}}{η} ;$$

where η is the converter's efficiency. As a result, power losses and cost for the isolated DC to DC converter 120 of FIG. 21 can be significantly reduced in comparison to the standard step-down DC to DC converter.

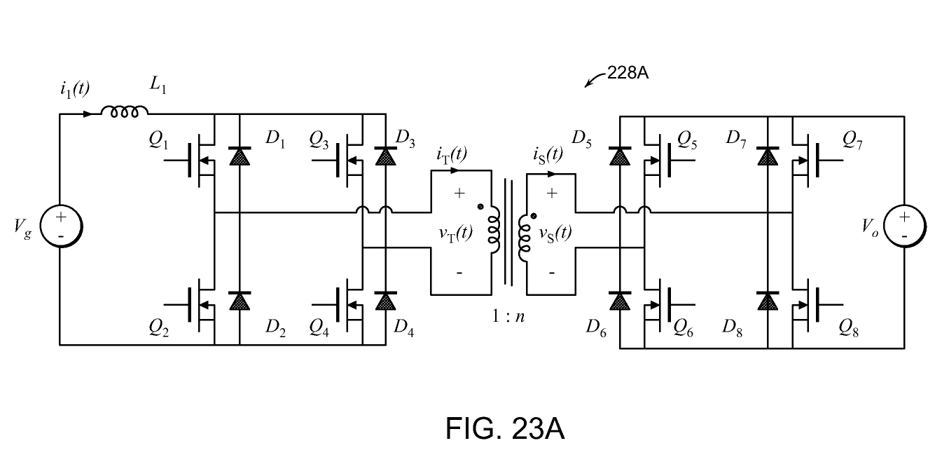

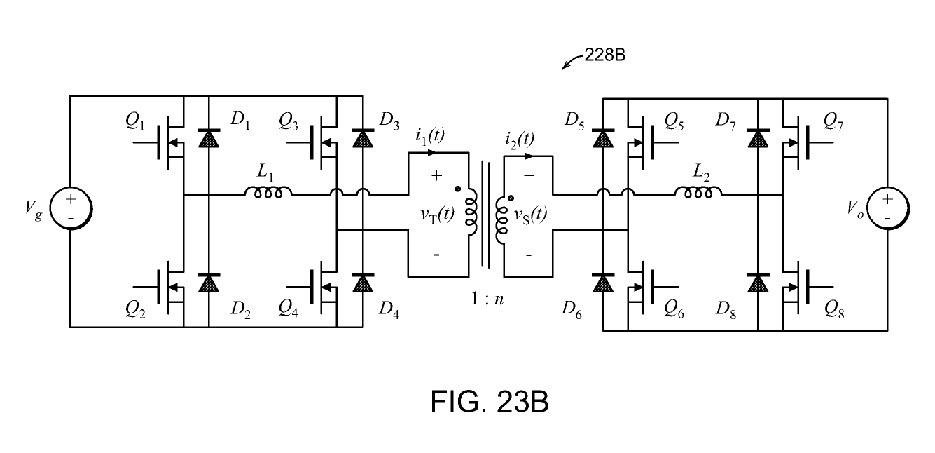

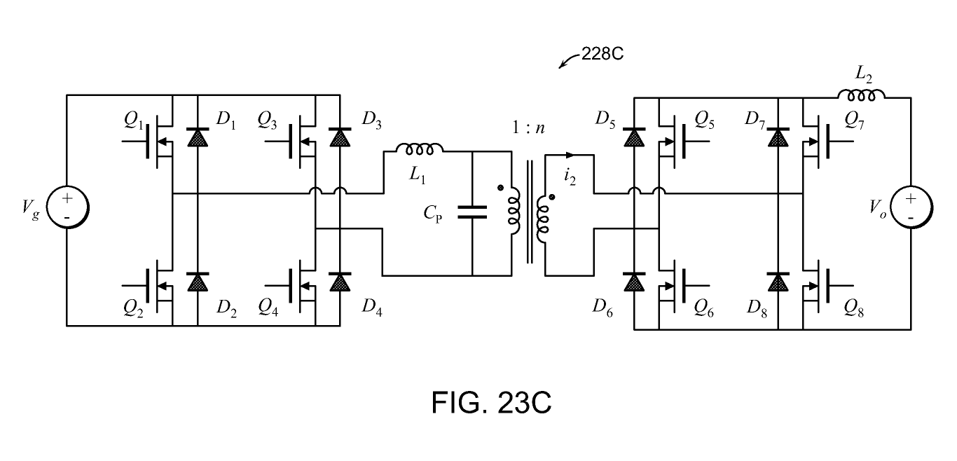

In the high voltage MPPT bidirectional charge controller 10 of the present invention, the isolated DC to DC converter 220 is implemented to include a bidirectional isolated DC to DC converter configuration 228 as shown in FIG. 22. The bidirectional isolated DC to DC converter configuration 228 enables the converter 220 to operate as a step-up converter in one direction and as a step-down converter in the opposite direction. FIGS. 23A, 23B and 23C depict electrical diagrams illustrating specific examples of bidirectional isolated DC to DC converter configurations 228A, 228B and 228C, respectively, that may be used as the bidirectional isolated DC to DC converter configuration 228 employed in the isolated DC to DC converter 220 of FIG. 22. The converter configuration 228A depicted in FIG. 23A represents a full-bridge bidirectional isolated DC to DC converter configuration, characterized by inductance in the DC link. A dual active full-bridge bidirectional isolated DC to DC converter configuration 228B is depicted in FIG. 23B, characterized by inductance in the transformer windings. A parallel resonant bidirectional isolated DC to DC converter configuration 228C is shown in FIG. 23C, characterized by resonant variation. The bidirectional isolated DC to DC converter 220 can replace any non-isolated step-up DC to DC converter or any non-isolated step-down DC to DC converter. The bidirectional characteristics of the arrangement depicted in FIG. 22 create an efficient and economical system that allows maximum power point tracking of a high voltage photovoltaic array 14 while simultaneously feeding a high voltage DC load 18 and providing interface to a battery bank 16 (DC Load/Source). When the maximum output power of the photovoltaic array 14 is higher than the high voltage DC load 18, the bidirectional isolated DC to DC converter configuration 228 of the charge controller 10 delivers the power difference to the battery bank 16. When the power required by the high voltage load 18 is higher than the maximum power output of the PV array 14, the converter 220 takes the power difference from the battery bank 16 and delivers it to the high voltage load 18. In both cases, maximum power point tracking can be performed.

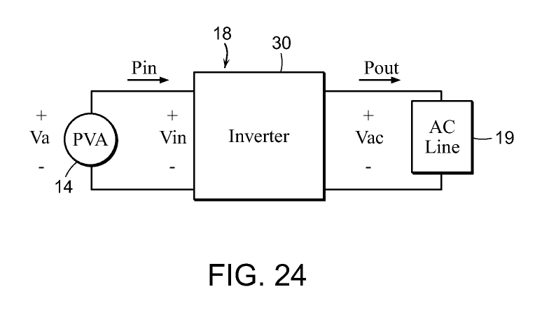

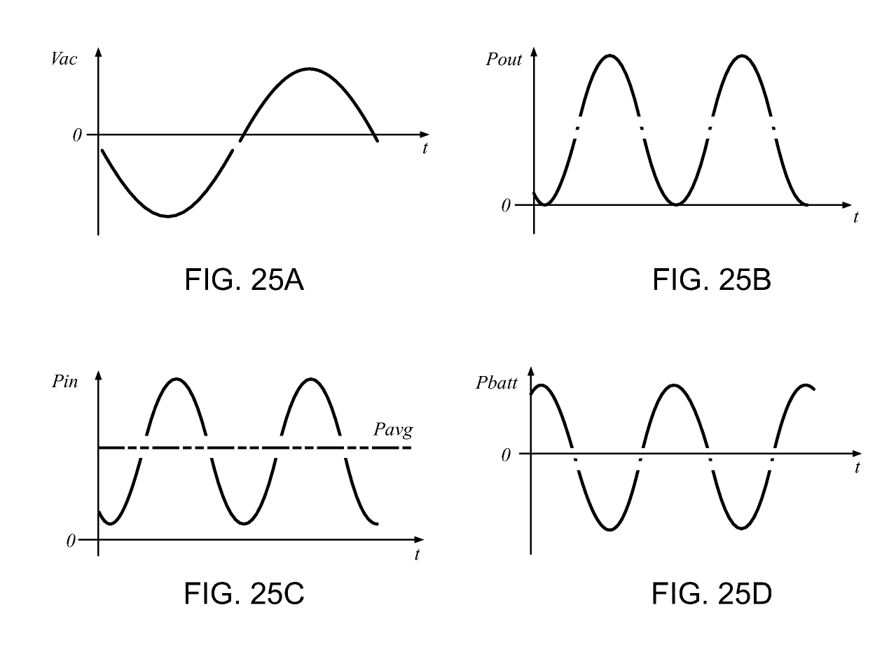

The high voltage DC load 18 may be an on-grid inverter 30, which may be a single-phase or three-phase on-grid inverter as depicted in FIG. 24 and as conventionally employed in grid-connected photovoltaic systems to deliver electrical power from the PV array 14 to a public utility grid 19. The inverter 30 operates to convert the high voltage DC current received from the bidirectional isolated DC to DC converter configuration 228 of the charge controller 10 into AC current appropriate for delivery to the public utility grid 19. FIG. 25A depicts the frequency of the voltage (V_{ac}) supplied to the AC line of the utility grid 19 by a low harmonic distortion inverter 30. FIG. 25B demonstrates that the power (P_{OUT}) delivered to the utility grid 19 by the inverter 30 varies at twice the frequency of the voltage V_{ac}. Accordingly, after including power losses, the input power (P_{iN}) drawn by the on-grid inverter 30 appears similar to a slightly distorted sine wave raised by a DC amount as shown in FIG. 25C. In this situation, the controller 10 would track the maximum power operating point of the PV array, which corresponds to average power (P_{Avg}) in FIG. 25C, by adjusting battery input power (P_{batt}), shown in FIG. 25D, to match the difference between the maximum power operating point of the PV array and the input power required by the on-grid inverter 30. Providing the grid-connected PV system 12 with the high voltage MPPT bidirectional charge controller 10 in combination with the battery bank 16 makes it possible for the inverter 30 to closely follow the maximum power operating point of the PV array 14 without requiring the inverter 30 to have large energy storage elements, such as capacitors or inductors. The controller 10 eliminates the control problems that are normally present at higher input voltages, reduces cost, decreases power losses, and avoids having any of the electrical components of the converter configuration 228 subjected to the peak output current. In addition to supplying ripple, the controller 10 is advantageous for supplying backup power when the utility grid 19 is down and the inverter 30 is in back-up mode. When the inverter 30 is in backup mode, the controller 10 operates in a back-up mode whereby, if the power that the connected AC load 21 requires is greater than available PV power, the battery bank 16 can supply the negative power difference to the inverter 30 and, if the power required by the AC load 21 is less than the available PV power, the battery bank 16 can absorb the extra power, i.e. positive power difference, and charge (if needed).

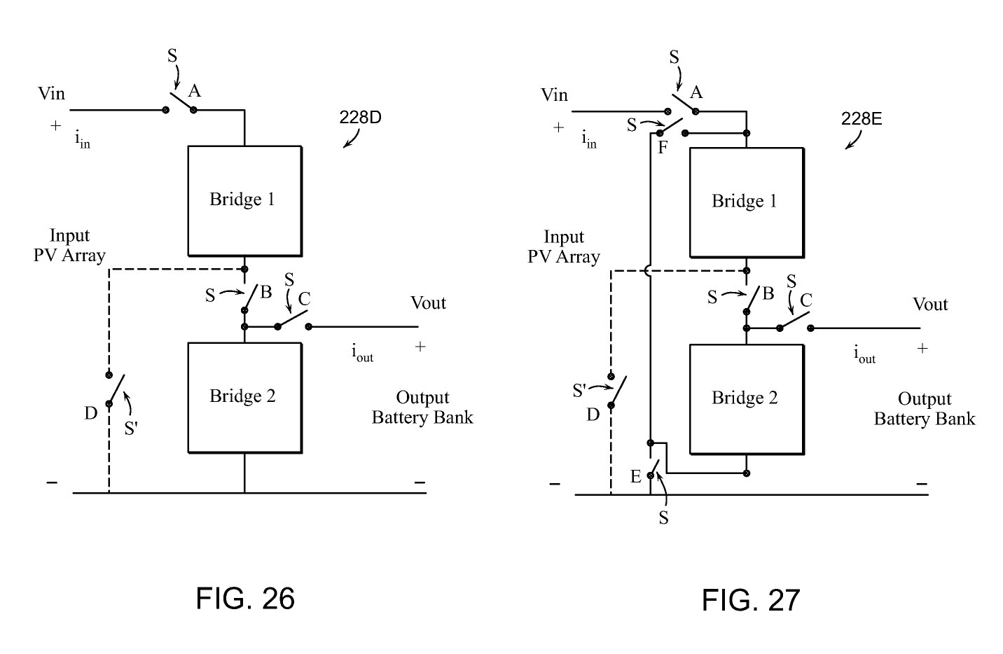

FIG. 26 depicts a modified bidirectional isolated DC to DC converter configuration 228D for use as the bidirectional isolated DC to DC converter configuration 228 of the bidirectional isolated DC to DC converter 220 of the bidirectional charge controller 10 in the PV system 12 of FIG. 22. The two halves of the bidirectional isolated DC to DC converter configuration 228D are shown as Bridge 1 and Bridge 2. The converter configuration 228D further includes a switch S which is needed to prevent current flowing back from the battery bank at night to the PV array, i.e. when Vᵢₙ is less than Vₒᵤₜ. The switch S may be located anywhere along the electrical path between the battery bank and the PV array, including within the Bridges 1 and 2 themselves. Locations A, B and C are appropriate locations for the switch S to accomplish switching in the positive leg of the circuit, it being appreciated that only one switch S is necessary. It is also possible to locate the switch S to accomplish switching in the negative leg of the circuit. The switch S may be an electronic device, such as a MOSFET, or a mechanical switch or relay. Locations A and B may be considered equivalent, and the switch S in these locations need only be rated to the input current. The switch S located at location C would need to be rated for the output current. If Vᵢₙ is greater than Vₒᵤₜ, then iᵢₙ is less than iₒᵤₜ, such that locations A or B may result in less loss than location C. Locating the switch S at location B allows an additional switch S′ to be added at location D. The switches S and S″ at locations B and D, respectively, cannot be closed at the same time. When the switch S at location B is open, the switch S″ at location D may be turned on if desired. This would have the effect of completely separating the two converter configuration halves, i.e. Bridge 1 and Bridge 2, whereby the converter 220 would operate like a typical isolated converter although the negatives would be common. The voltage applied to Bridge 1 is:

switch S at location B closed,switch S′ at location D open=Vᵢₙ−Vₒᵤₜ;

switch S at location B open,switch S′ at location D closed=Vᵢₙ.

The foregoing arrangement is advantageous in order to extend the low input voltage operating range by the amount of Vₒᵤₜ.

FIG. 27 illustrates a further modified bidirectional isolated DC to DC converter configuration 228E for use as the bidirectional isolated DC to DC converter configuration 228 of the bidirectional charge controller 10 in the PV system 12 of FIG. 22. The further modified bidirectional isolated DC to DC converter configuration 228E is similar to the bidirectional isolated DC to DC converter configuration 228D but includes the additional switches S at locations E and F, allowing Bridge 2 to be configured “above” Bridge 1 if the output voltage V_{OUT} needs to be higher than the input voltage V_{IN}. It would also be possible to configure Bridge 1 alongside Bridge 2. The bidirectional isolated DC to DC converter configuration 228 may therefore be considered variably configurable with Bridge 1 and Bridge 2 being variably arrangeable within the DC to DC converter 220. Bridge 1 and Bridge 2 in FIGS. 26 and 27 can be any isolated DC to DC converter configuration including full bridge, half bridge, push-pull and flyback DC to DC converter configurations, for example. The DC to DC converter configurations of FIGS. 23A, 23B and 23C may be used as Bridge 1 and Bridge 2.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. A high voltage maximum power point tracking bidirectional charge controller for photovoltaic systems having a high voltage photovoltaic array, a battery bank and a high voltage DC load, comprising
a bidirectional isolated DC to DC converter electrically connectable to the high voltage photovoltaic array, the battery bank, and the high voltage DC load of the photovoltaic system, said converter receiving DC input from the high voltage photovoltaic array and operating in a first direction to step-down the voltage of the DC input received from the photovoltaic array to obtain a stepped-down DC output of appropriate voltage to be delivered from said converter to the battery bank to charge the battery bank, said converter receiving DC input from the battery bank and operating in a second direction to step-up the voltage of the DC input received from the battery bank to obtain a stepped-up DC output of appropriate voltage to be delivered from said converter to the high voltage DC load, and said converter simultaneously performing maximum power point tracking of the high voltage photovoltaic array.

2. The high voltage maximum power point tracking bidirectional charge controller recited in claim 1 wherein said converter includes a full-bridge bidirectional isolated DC to DC converter configuration.

3. The high voltage maximum power point tracking bidirectional charge controller recited in claim 1 wherein said converter includes a dual active full-bridge bidirectional isolated DC to DC converter configuration.

4. The high voltage maximum power point tracking bidirectional charge controller recited in claim 1 wherein said converter includes a parallel resonant bidirectional isolated DC to DC converter configuration.

5. The high voltage maximum power point tracking bidirectional charge controller recited in claim 1 wherein said converter includes a first bridge, a second bridge, and a switch located along the electrical path between the photovoltaic array and the battery bank, said switch preventing current from flowing from the battery bank back to the photovoltaic array when the voltage of the DC input from the photovoltaic array to said converter is less than the voltage of the DC output from said converter to the battery bank.

6. The high voltage maximum power point tracking bidirectional charge controller recited in claim 5 wherein said switch is located along the electrical path to be rated for the input current of the DC input from the photovoltaic array.

7. The high voltage maximum power point tracking bidirectional charge controller recited in claim 5 wherein said switch is located along the electrical path to be rated for the output current of the DC output from said converter to the battery bank.

8. The high voltage maximum power point tracking bidirectional charge controller recited in claim 5 wherein said first bridge and said second bridge are variably arrangeable within said DC to DC converter.

9. A high voltage maximum power point tracking bidirectional charge controller for grid-connected photovoltaic systems having a high voltage photovoltaic array, a battery bank, and a grid-connected inverter for transforming DC electricity produced by the photovoltaic array into AC electricity appropriate for being supplied to a public utility grid, comprising
a bidirectional isolated DC to DC converter electrically connectable to the high voltage photovoltaic array, the battery bank, and the inverter of the photovoltaic system, said converter receiving DC input from the high voltage photovoltaic array and operating in a first direction to step-down the voltage of the DC input received from the photovoltaic array to obtain a stepped-down DC output of appropriate voltage to be delivered from said converter to the battery bank to charge the battery bank, said converter receiving DC input from the battery bank and operating in a second direction to step-up the voltage of the DC input received from the battery bank to obtain a stepped-up DC output of appropriate voltage to be delivered from said converter to the grid-connected inverter, and said converter simultaneously performing maximum power point tracking of the high voltage photovoltaic array.

10. The high voltage maximum power point tracking bidirectional charge controller recited in claim 9 wherein said converter includes a full-bridge bidirectional isolated DC to DC converter configuration.

11. The high voltage maximum power point tracking bidirectional charge controller recited in claim 9 wherein said converter includes a dual active full-bridge bidirectional isolated DC to DC converter configuration.

12. The high voltage maximum power point tracking bidirectional charge controller recited in claim 9 wherein said converter includes a parallel resonant bidirectional isolated DC to DC converter configuration.

13. The high voltage maximum power point tracking bidirectional charge controller recited in claim 9 wherein said converter includes a first bridge, a second bridge, and a switch located along the electrical path between the photovoltaic array and the battery bank, said switch preventing current from flowing from the battery bank back to the photovoltaic array when the voltage of the DC input from the photovoltaic array to said converter is less than the voltage of the DC output from said converter to the battery bank.

14. The high voltage maximum power point tracking bidirectional charge controller recited in claim 13 wherein said switch is located along the electrical path to be rated for the input current of the DC input from the photovoltaic array.

15. The high voltage maximum power point tracking bidirectional charge controller recited in claim 13 wherein said switch is located along the electrical path to be rated for the output current of the DC output from said converter to the battery bank.

16. The high voltage maximum power point tracking bidirectional charge controller recited in claim 13 wherein said first bridge and said second bridge are variably arrangeable within said DC to DC converter.

17. A high voltage maximum power point tracking bidirectional charge controller for grid-connected photovoltaic systems having a high voltage photovoltaic array, a battery bank and a grid-connected inverter for transforming DC electricity produced by the photovoltaic array into AC electricity appropriate for being supplied to a public utility grid and to an AC load, comprising
a bidirectional isolated DC to DC converter electrically connectable to the high voltage photovoltaic array, the battery bank, and the inverter of the photovoltaic system, said converter receiving DC input from the high voltage photovoltaic array and operating in a first direction to step-down the voltage of the DC input received from the photovoltaic array to obtain a stepped-down DC output of appropriate voltage to charge the battery bank, said converter delivering the stepped-down DC output to the battery bank to charge the battery bank, said converter receiving DC input from the battery bank and operating in a second direction to step-up the voltage of the DC input received from the battery bank to obtain a stepped-up DC output of appropriate voltage to be delivered from said converter to the grid-connected inverter, said converter delivering the stepped-up DC output to the grid-connected inverter for transformation by the inverter into AC electricity appropriate for being supplied to the public utility grid and the AC load, said converter operating in a back-up mode when the public utility grid is down whereby said converter supplies the stepped-up DC output from the battery bank to the inverter to power the AC load when the AC load requires more power than is available from the photovoltaic array and said converter supplies the stepped-down DC output from the photovoltaic array to charge the battery, if needed, when the AC load requires less power than is available from the photovoltaic array, said converter simultaneously performing maximum power point tracking of the high voltage photovoltaic array.

18. The high voltage maximum power point tracking bidirectional charge controller recited in claim 17 wherein said converter is capable of receiving input from a high voltage photovoltaic array of up to 600V.

19. A method of charge control for grid-connected photovoltaic systems having a high voltage photovoltaic array, a battery bank and a grid-connected inverter, comprising the steps of
delivering DC electricity produced by the high voltage photovoltaic array as DC input to a bidirectional DC to DC converter of a maximum power point tracking charge controller;
stepping-down the voltage of the DC input in a first direction through the DC to DC converter to obtain a stepped-down DC voltage;
delivering the stepped-down DC voltage from the maximum power point tracking charge controller to the battery bank;
delivering DC electricity from the battery bank as DC input to the DC to DC converter;
stepping-up the voltage of the DC voltage in the battery bank in a second direction through a DC to DC converter to obtain a stepped-up DC voltage; and
delivering the stepped-up DC voltage from the maximum power point tracking charge controller to the grid-connected inverter.
